(19) United States
(12) Patent Application Publication
(10) Pub. No.: US 2005/0071703 A1
(43) Pub. Date: Mar. 31, 2005

(54) Fault-tolerant clock synchronisation

(76) Inventors: Dongik Lee, Sheffield (GB); Geoffrey Mackintosh Allan, Sheffield (GB)

Correspondence Address: MYERS BIGEL SIBLEY & SAJOVEC, PO BOX 37428, RALEIGH, NC, 27627, US

(21) Appl. No.: 10/499,432

(22) PCT Filed: Dec. 20, 2002
(86) PCT No.: PCT/GB02/05828

(30) Foreign Application Priority Data
Dec. 20, 2001 (GB) 0130467.4

(51) Int. Cl. G06F 13/42; H04L 7/00; H04L 5/00; G06F 1/12

(52) U.S. Cl. 713/400

(57) ABSTRACT

A clock synchronization method is described for a system including N clocks, at least three and at most N−1 of which are master candidate clocks. A start message is broadcast from the fastest master candidate clock. From each of the master candidate clocks, a response message including the local time of receipt of the start message according to the clock in question is broadcast. Using the information representing the times of receipt of the start message, the median master candidate clock is selected and becomes the master clock. The master clock determines the clock synchronisation error for each master candidate clock, using the information representing the times of receipt of the start message. If any such clock synchronisation error is excessive the master clock declassifies the clock in question as a master candidate clock and classifies another clock as a master candidate clock. This is achieved by broadcasting a classification message identifying which of the N clocks are to be classified as master candidate clocks. Next, the master clock broadcasts a synchronisation message including the local time of receipt of the classification message according to the master clock. Each of the other N−1 clocks is then synchronised with the master clock using that information and the local time of receipt of the classification message according to the clock in question.

### BACKGROUND TO THE INVENTION

This invention relates to fault-tolerant clock synchronisation in distributed real-time systems.

Distributed real-time systems consist of a set of nodes that communicate with one another by means of message passing. Each node contains a local real-time clock and since physical clocks do not keep perfect time, but can drift with respect to one another, the clocks must periodically be resynchronised to a common time reference. Such clock synchronisation is crucial to enable all nodes to agree on the time and is of particular importance in systems that schedule specific activities with reference to time. In the following discussion, the term “clock” will be used to describe not only the physical, real-time clock associated with a node, but also any device connected to a node that incorporates such a physical, real-time clock.

One sphere of application in which the importance of temporal agreement between nodes is paramount is the sphere of safety-critical applications. Safety-critical applications are applications in which faults that develop have the potential to result in death or serious physical injury. Examples are fly-by-wire or drive-by-wire systems as are used in the avionics and automotive industries, nuclear power plant control and medical robotics. Many of these systems make use of a controller area network or CAN bus.

Over the last two decades, a number of clock synchronisation methods have been proposed: Anceaume, E. & Puaut, I., “Performance evaluation of clock synchronization algorithms”, Tech. Report N3526, Unite de recherche INRIA Rennes, IRISA, Campus Universitaire de Beaulieu, 35042 Rennes Cedex, France, 1998; Shin, K. G. & Butler, R. W., “Fault-Tolerant Clock Synchronization in Distributed Systems”, IEEE Computer, pp. 33-42, October 1990. However, many of the published methods are too complicated to use for embedded real-time systems. For embedded systems, a master-slave architecture is widely used due to its simplicity: Gergeleit, M. & Streich, H., “Implementing a distributed high-resolution real-time clock using the CAN bus”, Proc. CIA 1st International CAN Conference (ICC), 1994, With a master-slave architecture, one node in the system is designated as the master clock, which generates the reference time. The other clocks, designated as the slaves, are periodically synchronised to the master clock time. Not only does the master-slave approach introduce only a small amount of traffic onto the bus, but also it is flexible for future modification. However, the master-slave approach has the significant drawback that a single fault in the master clock can lead to loss of synchronisation.

### SUMMARY OF THE INVENTION

One objective of embodiments of the present invention is to provide a master-slave based clock synchronisation method that can tolerate faults in the master clock. This is achieved by classifying some, but not all, of the clocks in the system as master candidate clocks for the time being. This group of clocks will be referred to as the master candidates group or MCG. The master clock is selected from the MCG. Any master candidate clock that is found to be faulty and therefore possesses an excessive clock synchronisation error, is removed from the MCG and its place taken by another clock.

Accordingly, embodiments of the present invention provide a clock synchronization method for a system including N clocks, comprising:
classifying at least three and at most N−1 of those clocks as master candidate clocks;
selecting one of the master candidate clocks and classifying it as a master clock;
synchronising each of the N clocks other than the master clock with the master clock; and
for each master candidate clock, determining whether its clock synchronisation error is excessive and, in response to an affirmative determination, declassifying that clock as a master candidate clock and classifying as a master candidate clock another of the N clocks that is not already classified as a master candidate clock.

If a fault develops in one of the master candidate clocks, which is sufficiently serious that the clock synchronisation error of the master candidate clock is excessive, then the clock will be removed from the MCG. Having been removed from the MCG, the clock is no longer available to be selected as the master clock. It will operate as a slave clock or be disabled or disregarded altogether.

The process of selecting a master clock from the MCG is an additional important consideration. For example, it may not be wise to choose either the fastest or the slowest master candidate clock as the master clock. If that were allowed, then a clock that develops a fault just as the master clock selection process is taking place, and therefore runs fast or slow, may be selected as the master clock for the subsequent clock synchronization operation. Alternatively, there may be situations in which it is preferable to select the fastest or slowest clock. In each case, information must be gathered on the relative clock rates of the various clocks in the MCG.

Accordingly, it is preferred that the process of selecting one of the master candidate clocks should comprise:
from one of the master candidate clocks, broadcasting a master selection initiation message;
from each of the other master candidate clocks, broadcasting a master selection response message including information representing the local time of receipt of the master selection initiation message according to the clock in question; and
selecting one of the master candidate clocks using the information representing the local times of receipt of the master selection initiation message.

It will be understood that for each master candidate clock, the local time of receipt of the master selection initiation message will be determined by two factors, namely propagation delay, which can safely be assumed to be negligible, and the clock rate of the local clock.

For convenience, the master selection initiation message will be broadcast from the fastest master candidate clock. This means that each master candidate clock can be adapted to broadcast the master selection initiation message at a given local time unless such a message has already been broadcast by another master candidate clock. Thus, all the master candidate clocks operate identically and the master selection initiation message will in the normal course of events be broadcast by whichever of the clocks is running fastest. In some cases, as explained above, it may not be wise to choose the fastest master candidate clock as the master clock. Thus, the system can be designed to discount whichever of the master candidate clocks broadcast the master selection initiation message.

On the other hand, it is convenient to determine the clock synchronisation error for each master candidate clock using the information representing the local times of receipt of the master selection initiation message. In these circumstances, the local time of receipt of the master selection initiation message for all the master candidate clocks ought to be known. It cannot be assumed that the local time of receipt of the master selection initiation message according to the broadcasting clock will be calculable from the time of broadcast, since even though propagation delays may be negligible, there may nonetheless be unpredictable pre-transmission delays, associated for example with bus or channel arbitration and seizure.

In these circumstances, it is preferred that the process of selecting one of the master candidate clocks should comprise:
from one of the master candidate clocks, broadcasting a master selection initiation message;
from each of the master candidate clocks, broadcasting a master selection response message including information representing the local time of receipt of the master selection initiation message according to the clock in question; and
selecting one of the master candidate clocks using the information representing the local times of receipt of the master selection initiation message.

In the light of the above discussion, it is another objective of the present invention to provide a master-slave based clock synchronisation method with improved real-time clock uniformity. This is achieved by selecting a master clock from an MCG according to clock rate characteristics.

Accordingly, embodiments of the present invention provide a clock synchronization method for a system including N clocks, comprising:
classifying at least three and at most N−1 of those clocks as master candidate clocks;
from one of the master candidate clocks, broadcasting a master selection initiation message;
from each of the other master candidate clocks, broadcasting a master selection response message including information representing the local time of receipt of the master selection initiation message according to the clock in question;
selecting one of the master candidate clocks using the information representing the local times of receipt of the master selection initiation message and classifying it as a master clock; and
synchronising each of the N clocks other than the master clock with the master clock.

To the same end, and as discussed above, embodiments of the present invention also provide a clock synchronization method for a system including N clocks, comprising:
classifying at least three and at most N−1 of those clocks as master candidate clocks;
from one of the master candidate clocks, broadcasting a master selection initiation message;
from each of the master candidate clocks, broadcasting a master selection response message including information representing the local time of receipt of the master selection initiation message according to the clock in question;
selecting one of the master candidate clocks using the information representing the local times of receipt of the master selection initiation message and classifying it as a master clock; and
synchronising each of the N clocks other than the master clock with the master clock.

In the case where the fastest or slowest of the master candidate clocks should not be selected as the master clock, it is preferred that the process of selecting one of the master candidate clocks using the information representing the local times of receipt of the master selection initiation message comprises selecting the median master candidate clock. In most systems this can be shown to maximise real-time clock uniformity.

Once a master candidate clock has been removed from the MCG owing to excessive clock synchronisation error, it makes sense to classify it as out of use, at least until it is repaired. Therefore, the method preferably comprises, in response to the affirmative determination, classifying as a faulty clock the clock that is declassified as a master candidate clock and classifying as a master candidate clock another of the N clocks that is not already classified as a master candidate clock or a faulty clock.

For convenience, the question whether the clock synchronisation error for each master candidate clock is excessive may be determined by the master clock. In such a case, following determination of that question, the master clock may broadcast a classification message identifying which of the N clocks are to be classified as master candidate clocks.

Again for convenience, synchronising each of the N clocks other than the master clock with the master clock may comprise:
from the master clock, broadcasting a synchronisation message including synchronisation information; and
synchronising each of the N clocks other than the master clock with the master clock using the synchronisation information.

If the master clock broadcasts both a classification message and a synchronisation message, the existence of the two messages may be used to advantage. In that case, synchronising each of the N clocks other than the master clock with the master clock may comprise:
from the master clock, broadcasting a synchronisation message including synchronisation information representing the local time of receipt of the classification message according to the master clock; and
synchronising each of the N clocks other than the master clock with the master clock using the synchronisation information and the local time of receipt of the classification message according to the clock in question.

The system may further include M slave clocks, and the method may further comprise synchronising each of the M slave clocks with the master clock. For convenience, the synchronising of each of the M slave clocks and the synchronising of each of the N clocks other than the master clock may be accomplished in common.

Another objective of embodiments of the present invention is to provide a clock that is capable of use in a master-slave based clock synchronisation method that can tolerate faults in the master clock. This is achieved by a clock that is classifiable as a master candidate clock, thus belonging to an MCG, or a master clock for the time being. When N such clocks are incorporated into a system, the system operates to remove any faulty clock from the MCG and replace it with another.

Accordingly, embodiments of the present invention provide a clock for use in a system including N clocks, of which one is classified as a master clock and at least three and at most N−1, including the master clock, are classified as master candidate clocks, the clock comprising control means adapted to operate as follows:
to record whether the clock is classified as a master clock or a master candidate clock;
if the clock is classified as a master clock, to determine, for each master candidate clock, whether its clock synchronisation error is excessive and, in response to an affirmative determination, to broadcast a classification message declassifying that clock as a master candidate clock and classifying as a master candidate clock another of the N clocks that is not already classified as a master candidate clock; and
if the clock is not classified as a master clock, to receive such a classification message broadcast from a master clock and, if that message classifies or declassifies it as a master candidate clock, to record that fact.

A further object of embodiments of the invention is to provide the controlling software for a clock that is capable of use in a master-slave based clock synchronisation method that can tolerate faults in the master clock. Accordingly, embodiments of the present invention provide a software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master clock, to determine, for each master candidate clock, whether its clock synchronisation error is excessive and, in response to an affirmative determination, to broadcast a classification message declassifying that clock as a master candidate clock and classifying as a master candidate clock another of the N clocks that is not already classified as a master candidate clock; and
if the clock is not classified as a master clock, to receive such a classification message broadcast from a master clock and, if that message classifies or declassifies it as a master candidate clock, to record that fact.

For convenience, clock synchronisation is achieved by the control means being further adapted to operate as follows, or the software cod being further adapted to cause the clock to operate as follows:
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

The process of selecting a master clock is an additional important consideration, as described above. Accordingly, the control means may be further adapted to operate as follows, or the software code may be further adapted to cause the clock to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

Alternatively, in cases where the local time of receipt of the master selection initiation message for all the master candidate clocks out to be known, the control means may be further adapted to operate as follows, or the software code being further adapted to cause the clock to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

In the light of the above discussion, it is another objective of embodiments of the present invention to provide a clock that is capable of use in a master-slave based clock synchronisation method with improved real-time clock uniformity. This is achieved by a clock that is classifiable as a master candidate clock, thus belonging to an MCG, or a master clock for the time being, When N such clocks are incorporated into a system, the system operates to select a master clock from the MCG according to clock rate characteristics.

Accordingly, embodiments of the present invention provide a clock for use in a system including N clocks, of which one is classified as a master clock and at least three and at most N−1, including the master clock, are classified as master candidate clocks, the clock comprising control means adapted to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

To the same end, embodiments of the present invention also provide a clock for use in a system including N clocks, of which one is classified as a master clock and at least three and at most N−1, including the master clock, are classified as master candidate clocks, the clock comprising control means adapted to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including-information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

A further object of embodiments of the invention is to provide the controlling software for a clock that is capable of use in a master-slave based clock synchronisation method with improved real-time clock uniformity. Accordingly, embodiments of the present invention provide a software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

To the same end, embodiments of the present invention provide a software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

As discussed above, the clock synchronisation error may be determined for each master candidate clock using the information representing the local times of receipt of the master selection initiation message and it is preferred that the control means be adapted to operate so, or the software code be adapted to cause the clock to operate so. The control means may be adapted to select the median master candidate clock, or the software code may be adapted to cause it to do so.

Once a master candidate clock has been removed from the MCG owing to excessive clock synchronisation error, it makes sense to classify it as out of use, at least until it is repaired. Therefore, it is preferred that the control means be further adapted to operate as follows, or the software code be adapted to cause the clock to operate as follows:
to record whether the clock is classified as a faulty clock;
if the clock is classified as a master clock, in response to an affirmative determination of the question whether the clock synchronisation error of a master candidate clock is excessive, to broadcast a classification message classifying that clock as a faulty clock and classifying as a master candidate clock another of the N clocks that is not already classified as a master candidate clock or a faulty clock; and
if the clock is not classified as a master clock and such a classification message broadcast from a master clock classifies it as a faulty clock, to record that fact.

For convenience, the control means may be adapted to operate as follows, or the software code may be adapted to cause the clock to operate as follows:
if the clock is classified as a master clock, following the determination of the question whether the clock synchronisation error of each master candidate clock is excessive, to broadcast a classification message identifying which of the N clocks are to be classified as master candidate clocks.

As discussed above, such a classification message may be used to advantage in the synchronisation process. To this end, it is preferred that the control means be further adapted to operate as follows, or that the software code be further adapted to cause the clock to operate as follows:
if the clock is classified as a master clock, to broadcast a synchronisation message including synchronisation information representing the local time of receipt of the classification message according to the master clock; and
if the clock is not classified as a master clock, to receive such a synchronisation message broadcast from a master clock and to synchronise itself with the master clock using the synchronisation information and the local time of receipt of the classification message according to the clock in question.

### BRIEF DESCRIPTION OF THE DRAWINGS

Embodiments of the present invention will now be described by way of example with reference to the accompanying drawings in which:

FIGS. 1a and 1b are representations of the clock clustering scheme;

FIG. 2 is a time chart of the clock synchronisation method; and

FIG. 3 is a state diagram of the clock synchronisation process.

### DETAILED DESCRIPTION OF AN EMBODIMENT OF THE INVENTION

The embodiments of the present invention that will now be described provide a reliable clock synchronisation method for distributed real-time systems using a CAN bus. They make use of a number of features of the CAN protocol, which will briefly be described, with the result that a highly fault tolerant clock synchronisation system can be put in place using software alone.

1. Atomic Broadcasting

Atomic broadcasting is a feature of the CAN protocol that enables a node in the system to broadcast a message to every other node in the system. To prevent messages from more than one node being broadcast simultaneously, some form of bus arbitration process is used, but once bus access is granted by the arbitration process, the message is received substantially simultaneously by all the other nodes in the system. Receipt by the other nodes is is acknowledged.

By “substantially simultaneously” is meant at times that differ from one another by substantially less than the temporal granularity of the system. For example, a gas turbine may have a temporal granularity of 1 ms, meaning that it can be adequately serviced by a 1 kHz bus, but the size of the device is such that the longest propagation delay between system nodes will be less than 100 ns. That is less than 10% of the temporal granularity of the gas turbine.

2. Message Identifiers

Each message in the CAN protocol is marked with a message identifier. The message identifier includes at least an indication of the message priority. Typically, there are over 2000 priority levels, numbered in reverse order of priority. A message showing priority, “0” is the highest possible priority message.

3. A Postiori Time Stamping

A postiori time stamping is a technique for allowing synchronisation to take place as messages arrive at their destinations as opposed to when they leave their sources. Using a postiori time stamping in conjunction with atomic broadcasting allows latency errors to be cancelled out.

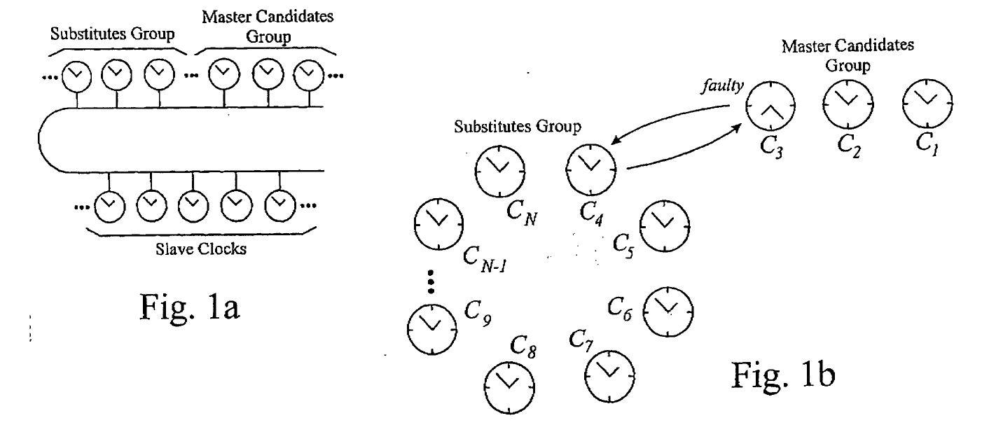

Embodiments of the present invention are based on a master-slave approach to establish as simple method as possible. They use a clustering technique that classifies all clock nodes in the system into groups. These groups are a master candidates group (MCG), a master clock substitutes group (MCSG) and a slave clock group (SCG). The technique is illustrated schematically in FIGS. 1a and 1b and is designed to overcome the traditional problems relating to master clock faults. The prevailing master clock is periodically selected from the MCG. As will be explained, by combining this clustering method and a master-slave architecture, embodiments of the present invention provide reliable and accurate reference time synchronisation. Every resynchronisation cycle, a selection mechanism chooses a median clock from the MCG as the master clock. The selection mechanism also identifies faulty clocks within the MCG. If any faulty clocks have been detected, they are replaced with non-faulty clocks from the MCSG.

Thus, at each resynchronisation cycle, only clocks in the MCG take part in the selection of a master. In contrast, clocks in the MCSG do not take part in the selection, and are only for replacing faulty clocks of the MCG. The remaining clocks in the system are slaves, which have to synchronise to the selected master clock, but are not required to broadcast any messages for clock synchronisation.

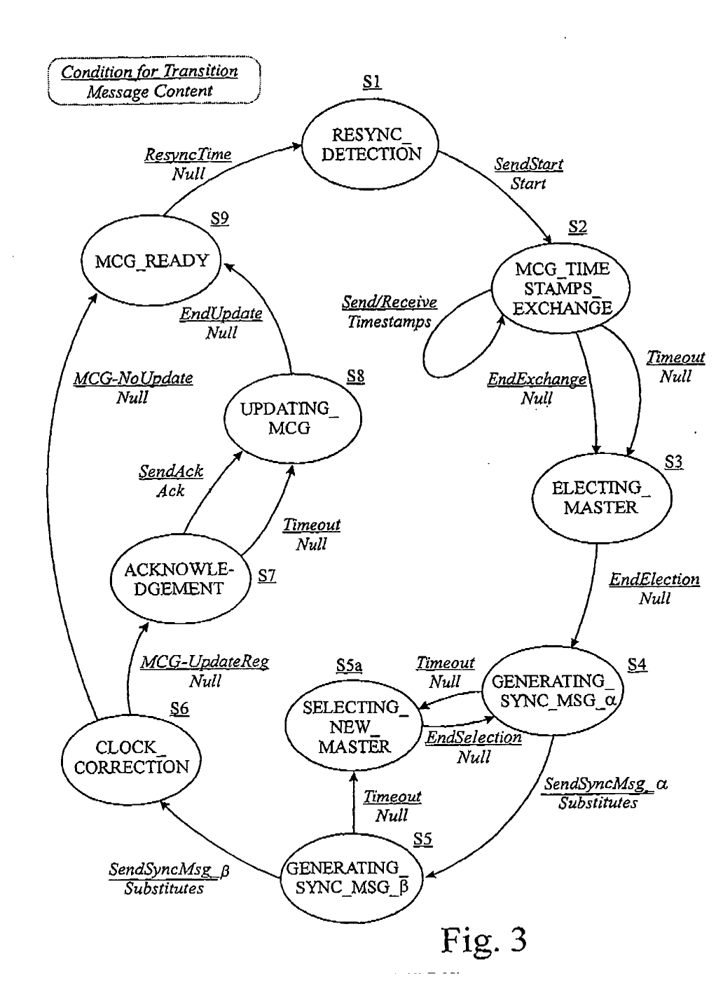

FIG. 3 is a state diagram of the master selection and synchronisation process utilising the clustering technique described to achieve synchronisation of the clocks in each periodic resynchronisation cycle. The system illustrated in FIG. 3 includes N+M clocks in total. Of these, N clocks are capable of serving as the master clock and, assuming they are not faulty, are at any one time distributed across the MCG and the MCSG. The remaining M clocks are permanent slave clocks and are always in the SCG. Each of the N potential master clocks is assigned an unique priority number, which would typically be hard-wired, but may be achieved during an initialisation process on power-up of the system. Moreover, each of the clocks in the system is hard-wired with information identifying the number K of clocks that are to form the MCG. The value of K is at least three and may be as many as N−1. In the preferred embodiment, K is exactly three. This leaves N−K clocks in the MCSG, assuming none of the clocks is faulty, which means that there is at least one clock and at most N−3 clocks in the MCSG, from which a replacement for a faulty clock in the MCG can be chosen. When the system is powered up, the K clocks having the highest priorities, e.g. Clocks C₁, C₂, . . . C_{K}, organise themselves into the MCG. The remaining N−K clocks having the lowest priorities, e.g. priorities C_{K+1}, C_{K+2}, . . . C_{N-1}, C_{N}, organise themselves into the MCSG. This self-organisation takes place by each of the clocks setting the appropriate bits in a local assignment register. With the clocks so organised, the system enters the state diagram of FIG. 3 at state S1. Note that as yet, no master clock has been selected.

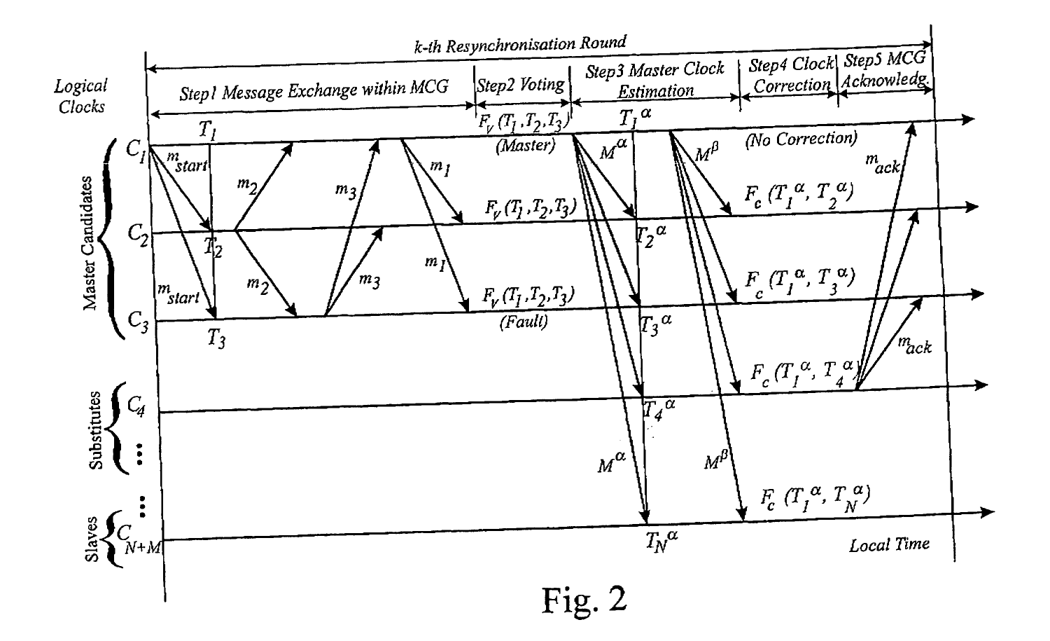

Each of the K clocks in the MCG, i.e. each clock having the MCG bit set in its assignment register, waits for a predetermined period of time, the resynchronisation time, as measured locally. However, because each of these clocks will be running at a slightly different rate, one of them, namely the fastest, will reach the resynchronisation time first. This state is represented by state S2 in FIG. 3. For the sake of convenience, it will be assumed that the fastest clock is clock C1, although it need not be. When clock C₁ reaches the resynchronisation time, it broadcasts a master selection initiation message mₛₜₐᵣₜ to all the other clocks in the system using the atomic broadcasting functionality of the CAN protocol, as illustrated in FIG. 2. The master selection initiation message mₛₜₐᵣₜ is broadcast with priority “0” and therefore takes precedence over any other pending messages at the next bus arbitration round. The master-selection initiation message instructs each of the other clocks in the MCG, i.e. each other clock having the MCG bit set in its assignment register, to take a snapshot of the local time, i.e. the time denoted by that clock, at the time it receives the master selection initiation message mₛₜₐᵣₜ. This snapshot is termed a “timestamp”. Receipt of the master selection initiation message mₛₜₐᵣₜ is acknowledged by means of an acknowledge bit on, the CAN bus. When clock C₁ detects the acknowledge bit, it too takes a timestamp. Thus, K timestamps are taken at substantially the same time, each representing a local time T₁, T₂, . . . T_{K}.

There then follows a round of timestamp exchanges between the clocks in the MCG, representing in FIG. 3 by state S3. Each of the K clocks in the MCG, i.e. each clock having the MCG bit set in its assignment register, broadcasts a master selection response message m₁, M₂, . . . m_{K} to all the other clocks in the system using the atomic broadcasting functionality of the CAN protocol, as illustrated in FIG. 2. The master selection response messages m₁, m₂, . . . m_{K} are broadcast with priority “0” and therefore take precedence over any other pending messages at the next bus arbitration round. In this way, each of the clocks in the MCG is informed of the timestamp taken by each of the others. Since these timestamps were taken at substantially the same time, each clock in the MCG is able to determine the relative speed of all the clocks in the MCG. The timestamp representing the latest time will belong to the fastest clock, which in this case is clock C₁. The timestamp representing the earliest time will belong to the fastest clock. The timestamp representing the median time will belong to the median clock. This median clock is elected as the master clock. It sets the master clock bit in its assignment register. If there is no single median clock because for example. K is an even number, whichever of the two median clocks has the highest priority is chosen. This is represented by state S4 in FIG. 3 and by the voting algorithm Fᵥ (T₁, T₂, T₃) in FIG. 2. FIG. 2 shows clock C₁ being elected as master.

It is apparent that if the timestamps were used solely for the purpose of determining which clock is to be elected as master, then the timestamp T₁ taken by the clock C₁ might not be required. Because clock C₁ is known to be the fastest clock, at least at the time when the master selection initiation message mₛₜₐᵣₜ is broadcast, it might be excluded from being elected as the master clock. Similarly, because it lies at the fastest extreme of the clock population, the median clock can still be determined. A system in which such a simplified process is used is within the scope of embodiments of the present invention, but as will be explained below, there are significant advantages associated with taking the timestamp T₁ in the fastest clock C₁. Clearly, in a system in which the clocks can drift relative to one another, there is no guarantee that clock C₁ will still be the fastest clock at the time the master selection initiation message mₛₜₐᵣₜ is received. In such a case, the timestamp T₁ will be required to be taken by the clock C₁. FIG. 2 shows just such a case, in which one of the other clocks C₂, C₃ has caught up with and overtaken clock C₁ during the period between broadcast and receipt of the master selection initiation message mₛₜₐᵣₜ.

The elected master clock C₁, i.e. the clock that has both the MCG bit and the master clock bit set in its assignment register, then determines the clock synchronisation error for each of the other clocks C_{p (p≠1)} in the MCG. One way it can do this is simply to subtract the timestamp T_{p (p≠1)} from each of those clocks from its own timestamp T₁. If the different is excessive, that is to say outside a predetermined range, which will normally be centred on zero, then the clock in question, Tₚ is considered to be faulty. Even if the clock C₁ were not elected as master, this step can only be performed if all the clocks in the MCG, including clock C₁, have taken and exchanged timestamps. Indeed, it is possible for each of the clocks in the MCG or each of the clocks in the MCG and each of the clocks in the MCSG to perform this determination too. However, the master clock C₁, i.e. the clock that has both the MCG bit and the master clock bit set in its assignment register, then broadcasts a classification message M^{α} to all the other clocks in the system using the atomic broadcasting functionality of the CAN protocol, as illustrated in FIG. 2. The classification message M^{α} is broadcast with priority “0” and therefore takes precedence over any other pending messages at the next bus arbitration round. The content of the classification message M^{α} identifies which of the N clocks will be in the MCG for the next master election cycle. The master clock simply compiles a list of those clocks that broadcast a timestamp in response to the master selection initiation message, removes any that are determined to have excessive clock synchronisation errors and replaces them with an equal number of clocks from the MCSG. For simplicity, the highest priority clocks from the MCSG are chosen. This is represented by state S5a in FIG. 3. The modified list of clocks is broadcast as part of the classification message M^{α}, but not acted upon immediately. This state is represented by state S5 of FIG. 3.

The classification message M^{α} also instructs each of the other clocks in the MCG, i.e. each other clock having the MCG bit set in its assignment register, to take a timestamp at the time it receives the classification message M^{α}. Receipt of the classification message M^{α} is acknowledged by means of an acknowledge bit on the CAN bus. When clock C₁ detects the acknowledge bit, it too takes a timestamp. Thus, K timestamps are again taken at substantially the same time, each representing a local time T^{α}₁, T^{α}₂, . . . T^{α}_{K}, as shown in FIG. 2.

Next, the master clock C₁, i.e. the clock that has both the MCG bit and the master clock bit set in its assignment register, broadcasts a synchronisation message M^{α} to all the other clocks in the system using the atomic broadcasting functionality of the CAN protocol, as illustrated in FIG. 2. The synchronisation message M^{β} is broadcast with priority “0” and therefore takes precedence over any other pending messages at the next bus arbitration round. The classification message M^{β} contains the timestamp T^{α}₁ taken by the master clock C₁ at the time the classification message M^{α} was received. This state is represented by state S6 in FIG. 3. Each of the other K−1 clocks C_{p p≠1} in the MCG then calculates its clock synchronisation error by subtracting its timestamp T^{α}_{p p≠1} from the timestamp T^{α}₁ broadcast by the master clock and corrects itself accordingly. This is represented by state S7 in FIG. 3.

Only after this point, are the contents of the classification message M^{α} acted upon. Any clock that is currently in the MCG, i.e. any clock that has the MCG bit set in its assignment register, but is not identified as belonging to the MCG in the classification message M^{α}, resets the MCG bit in its assignment register and sets a fault bit. Any clock that is not currently in the MCG, i.e. any clock that does not have the MCG bit set in its assignment register, but is identified as belonging to the MCG in the classification message M^{α}, then inspects the fault bit in its assignment register. If that bit is clear, it broadcasts an acceptance message m_{ack} using the atomic broadcasting functionality of the CAN protocol, as illustrated in FIG. 2. The acceptance message m_{ack} is broadcast with priority “0” and therefore takes precedence over any other pending messages at the next bus arbitration round. On the other hand, if the fault bit is set, it broadcasts a rejection message m_{ack} using the atomic broadcasting functionality of the CAN protocol, as illustrated in FIG. 2. The synchronisation message m_{ack} is broadcast with priority “0” and therefore takes precedence over any other pending messages at the next bus arbitration round. The broadcast of a rejection message causes the next highest priority clock that is not currently in the MCG to inspect the fault bit in its assignment register. If that bit is clear, it broadcasts an acceptance message m_{ack}; if it is set, it broadcasts a rejection message m_{ack}. The process continues until a substitute is found. This is represented by state S8 in FIG. 3. The substitute sets the MCG bit in its assignment register, thus reconstituting the MCG. This is represented by state S9 in FIG. 3. The whole process then returns to state S1, which is where it began.

There are other ways in which the selection and vetting of substitute clocks can be achieved. Since all traffic on the CAN bus is public, each clock may keep a record of the clocks already found to be faulty. This record can be used to prevent the master clock from designating a high-priority but faulty clock as a substitute clock in the event of another clock fault in the MCG. In such a case, the designated substitute need not inspect its own fault bit, although it might to so as a safety double-check.

Clocks that are not in the MCG may also take a timestamp on receipt of the master selection initiation message mₛₜₐᵣₜ. This would allow them to determine their own clock synchronisation errors as compared with the elected master clock and whether those errors are excessive. This information can be used to accept or reject their designation as a substitute clock, preventing faulty clocks from being assigned to the MCG in the first place.

The steps described above are performed periodically and each time a new master is elected, any previous master resets the master clock bit in its own assignment register.

Embodiments of the present invention enjoys a number of advantages. The mechanism for electing a master clock from the MCG is very simple as only three candidate clocks are needed. The desired level of fault-tolerance can be achieved by choosing the appropriate number of substitute clocks. Moreover, the method is cost-effective because faulty clocks are not necessary to be removed from the system and those clocks that have been recovered from faults can easily re-join the system.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A clock synchronization method for a system including N clocks, comprising:
classifying at least three and at most N−1 of the N clocks as master candidate clocks;
selecting one of the master candidate clocks and classifying it as a master clock;
synchronising each of the N clocks other than the master clock with the master clock; and
for each master candidate clock, determining whether its clock synchronisation error is excessive and, in response to an affirmative determination, declassifying that clock as a master candidate clock and classifying as a master candidate clock another of the N clocks that is not already classified as a master candidate clock.

2. A method according to claim 1 wherein selecting one of the master candidate clocks comprises:
from one of the master candidate clocks, broadcasting a master selection initiation message;
from each of the other master candidate clocks, broadcasting a master selection response message including information representing the local time of receipt of the master selection initiation message according to the clock in question; and
selecting one of the master candidate clocks using the information representing the local times of receipt of the master selection initiation message.

3. A method according to claim 1 wherein selecting one of the master candidate clocks comprises:
from one of the master candidate clocks, broadcasting a master selection initiation message;
from each of the master candidate clocks, broadcasting a master selection response message including information representing the local time of receipt of the master selection initiation message according to the clock in question; and
selecting one of the master candidate clocks using the information representing the local times of receipt of the master selection initiation message.

4. A method according to claim 2 wherein the clock synchronisation error for each master candidate clock is determined using the information representing the local times of receipt of the master selection initiation message.

5. A method according to claim 2 wherein the master selection initiation message is broadcast from the fastest master candidate clock.

6. A method according to claim 5 wherein each master candidate clock is adapted to broadcast the master selection initiation message at a given local time unless such a message has already been broadcast by another master candidate clock.

7. A method according to claim 2 wherein selecting one of the master candidate clocks using the information representing the local times of receipt of the master selection initiation message comprises selecting the median master candidate clock.

8. A method according to, claim 1, further comprising:
in response to the affirmative determination, classifying as a faulty clock the clock that is declassified as a master candidate clock and classifying as a master candidate clock another of the N clocks that is not already classified as a master candidate clock or a faulty clock.

9. A method according to claim 1 wherein the question whether the clock synchronisation error for each master candidate clock is excessive is determined by the master clock.

10. A method according to claim 9 wherein, following determination of that question, the master clock broadcasts a classification message identifying which of the N clocks are to be classified as master candidate clocks.

11. A method according to claim 1 wherein synchronising each of the N clocks other than the master clock with the master clock comprises:
from the master clock, broadcasting a synchronisation message including synchronisation information; and
synchronising each of the N clocks other than the master clock with the master clock using the synchronisation information.

12. A method according to claim 10 wherein synchronising each of the N clocks other than the master clock with the master clock comprises:
from the master clock, broadcasting a synchronisation message including synchronisation information representing the local time of receipt of the classification message according to the master clock; and
synchronising each of the N clocks other than the master clock with the master clock using the synchronisation information and the local time of receipt of the classification message according to the clock in question.

13. A clock synchronization method for a system including N clocks, comprising:
classifying at least three and at most N−1 of the N clocks as master candidate clocks;
from one of the master candidate clocks, broadcasting a master selection initiation message;
from each of the other master candidate clocks, broadcasting a master selection response message including information representing the local time of receipt of the master selection initiation message according to the clock in question;
selecting one of the master candidate clocks using the information representing the local times of receipt of the master selection initiation message and classifying it as a master clock; and
synchronising each of the N clocks other than the master clock with the master clock.

14. A clock synchronization method for a system including N clocks, comprising:
classifying at least three and at most N−1 of the N clocks as master candidate clocks;
from one of the master candidate clocks, broadcasting a master selection initiation message;
from each of the master candidate clocks, broadcasting a master selection response message including information representing the local time of receipt of the master selection initiation message according to the clock in question;
selecting one of the master candidate clocks using the information representing the local times of receipt of the master selection initiation message and classifying it as a master clock; and
synchronising each of the N clocks other than the master clock with the master clock.

15. A method according to claim 13 wherein the master selection initiation message is broadcast from the fastest master candidate clock.

16. A method according to claim 15 wherein each master candidate clock is adapted to broadcast the master selection initiation message at a given local time unless such a message has already been broadcast by another master candidate clock.

17. A method according to claim 13 wherein selecting one of the master candidate clocks using the information representing the local times of receipt of the master selection initiation message comprises selecting the median master candidate clock.

18. A method according to claim 1 wherein the system further includes M slave clocks, the method further comprising synchronising each of the M slave clocks with the master clock.

19. A method according to claim 18 wherein the synchronising of each of the M slave clocks and the synchronising of each of the N clocks other than the master clock are accomplished in common.

20. A clock for use in a system including N clocks, of which one is classified as a master clock and at least three and at most N−1, including the master clock, are classified as master candidate clocks, the clock comprising a controller adapted to operate as follows:
to record whether the clock is classified as a master clock or a master candidate clock;
if the clock is classified as a master clock, to determine, for each master candidate clock, whether its clock synchronisation error is excessive and, in response to an affirmative determination, to broadcast a classification message declassifying that clock as a master candidate clock and classifying as a master candidate clock another of the N clocks that is not already classified as a master candidate clock; and
if the clock is not classified as a master clock, to receive such a classification message broadcast from a master clock and, if that message classifies or declassifies it as a master candidate clock, to record that fact.

21. A clock according to claim 20 wherein the controller is further adapted to operate as follows:
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

22. A clock according to claim 20 wherein the controller is further adapted to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

23. A clock according to claim 20 wherein the controller is further adapted to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

24. A clock according to claim 22 wherein the controller is adapted to determine the clock synchronisation error for each master candidate clock using the information representing the local times of receipt of the master selection initiation message.

25. A clock according to claim 21 wherein the controller is so adapted that the master candidate clock selected using the information representing the local times of receipt of the master selection initiation message is the median master candidate clock.

26. A clock according to claim 20 wherein the controller is further adapted to operate as follows:
to record whether the clock is classified as a faulty clock;
if the clock is classified as a master clock, in response to an affirmative determination of the question whether the clock synchronisation error of a master candidate clock is excessive, to broadcast a classification message classifying that clock as a faulty clock and classifying as a master candidate clock another of the N clocks that is not already classified as a master candidate clock or a faulty clock; and
if the clock is not classified as a master clock and such a classification message broadcast from a master clock classifies it as a faulty clock, to record that fact.

27. A clock according to claim 20 wherein the controller is adapted to operate as follows:
if the clock is classified as a master clock, following the determination of the question whether the clock synchronisation error of each master candidate clock is excessive, to broadcast a classification message identifying which of the N clocks are to be classified as master candidate clocks.

28. A clock according to claim 27 wherein the controller is further adapted to operate as follows:
if the clock is classified as a master clock, to broadcast a synchronisation message including synchronisation information representing the local time of receipt of the classification message according to the master clock; and
if the clock is not classified as a master clock, to receive such a synchronisation message broadcast from a master clock and to synchronise itself with the master clock using the synchronisation information and the local time of receipt of the classification message according to the clock in question.

29. A clock for use in a system including N clocks, of which one is classified as a master clock and at least three and at most N−1, including the master clock, are classified as master candidate clocks, the clock comprising a controller adapted to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

30. A clock for use in a system including N clocks, of which one is classified as a master clock and at least three and at most N−1, including the master clock, are classified as master candidate clocks, the clock comprising a controller adapted to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

31. A clock according to claim 29 wherein the controller is adapted to determine the clock synchronisation error for each master candidate clock using the information representing the local times of receipt of the master selection initiation message.

32. A clock according to claim 29 wherein the controller is so adapted that the master candidate clock selected using the information representing the local times of receipt of the master selection initiation message is the median master candidate clock.

33. A software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master clock, to determine, for each master candidate clock, whether its clock synchronisation error is excessive and, in response to an affirmative determination, to broadcast a classification message declassifying that clock as a master candidate clock and classifying as a master candidate clock another of the N clocks that is not already classified as a master candidate clock; and
if the clock is not classified as a master clock, to receive such a classification message broadcast from a master clock and, if that message classifies or declassifies it as a master candidate clock, to record that fact.

34. A software product according to claim 33 wherein the software code is further adapted to cause the clock to operate as follows:
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

35. A software product according to claim 33 wherein the software code is further adapted to cause the clock to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

36. A software product according to claim 33 wherein the software code is further adapted to cause the clock to operate as follows:
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock.

37. A software product according claim 35 wherein the software code is adapted to cause the clock to determine the clock synchronisation error for each master candidate clock using the information representing the local times of receipt of the master selection initiation message.

38. A software product according to claim 34 wherein the software code is so adapted that the master candidate clock selected using the information representing the local times of receipt of the master selection initiation message is the median master candidate clock.

39. A software product according to claim 33 wherein the software code is further adapted to cause the clock to operate as follows:
to record whether the clock is classified as a faulty clock;
if the clock is classified as a master clock, in response to an affirmative determination of the question whether the clock synchronisation error of a master candidate clock is excessive, to broadcast a classification message classifying that clock as a faulty clock and classifying as a master candidate clock another of the N clocks that is not already classified as a master candidate clock or a faulty clock; and
if the clock is not classified as a master clock and such a classification message broadcast from a master clock classifies it as a faulty clock, to record that fact.

40. A software product according to claim 33 wherein the software code is further adapted to cause the clock to operate as follows:
if the clock is classified as a master clock, following the determination of the question whether the clock synchronisation error of each master candidate clock is excessive, to broadcast a classification message identifying which of the N clocks are to be classified as master candidate clocks.

41. A software product according to claim 40 in which wherein the software code is further adapted to cause the clock to operate as follows:
if the clock is classified as a master clock, to broadcast a synchronisation message including synchronisation information representing the local time of receipt of the classification message according to the master clock; and
if the clock is not classified as a master clock, to receive such a synchronisation message broadcast from a master clock and to synchronise itself with the master clock using the synchronisation information and the local time of receipt of the classification message according to the clock in question.

42. A software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message is broadcast by another master candidate clock before the given local time, to receive the master selection initiation message and to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

43. A software product for a clock comprised in a system including N clocks, of which one is classified as a master clock and at least three and at most N−1, including the master clock, are classified as master candidate clocks, the software product comprising software code adapted to cause the clock to operate as follows:
to record whether the clock is classified as a master clock or a master candidate clock;
if the clock is classified as a master candidate clock, to broadcast a master selection initiation message at a given local time unless such a master selection initiation message has already been broadcast by another master candidate clock;
if the clock is classified as a master candidate clock and such a master selection initiation message has been broadcast, to broadcast a master selection response message including information representing the local time of receipt of the master selection initiation message;
if the clock is classified as a master candidate clock, to select one of the master candidate clocks using the information representing the local times of receipt of the master selection initiation message and, if in so doing it selects itself, to record the fact that it is classified as a master clock;
if the clock is classified as a master clock, to broadcast a synchronisation message including synchronisation information; and
if the clock is not classified as a master clock, to receive such a synchronisation message broadcast from a master clock and to synchronise itself with the master clock using the synchronisation information.

44. A software product according to claim 42 wherein the software code is adapted to cause the clock to determine the clock synchronisation error for each master candidate clock using the information representing the local times of receipt of the master selection initiation message.

45. A software product according to claim 42 wherein the software code is so adapted that the master candidate clock selected using the information representing the local times of receipt of the master selection initiation message is the median master candidate clock.

46. (Canceled)

47. (Canceled)

48. (Canceled)
